(19) United States
(12) Patent Application Publication
(10) Pub. No.: US 2023/0321782 A1
(43) Pub. Date: Oct. 12, 2023

(54) CHAMFERING KNIFE HOLDER

(71) Applicant: SHIN-YAIN INDUSTRIAL CO., LTD., Taichung City (TW)

(72) Inventor: Pen-Hung CHEN, Taichung City (TW)

(21) Appl. No.: 17/658,486

(22) Filed: Apr. 8, 2022

(51) Int. Cl. B24B 3/20; B23Q 3/06

(52) U.S. Cl. CPC B24B 3/20; B23Q 3/06

(57) ABSTRACT

A chamfering knife holder includes a mounting cover, a protrusion, a mounting assembly, a first containing space, a second containing space, and a resilient element. The protrusion circularly protrudes from an internal peripheral surface of the mounting cover and is enclosed to form a through hole. The mounting assembly is detachably and movably mounted in an interior of the mounting cover. The first containing space and the second containing space are both enclosed by the mounting cover, the protrusion, and the mounting assembly and communicate with each other via the through hole. The resilient element is selectively disposed in the first containing space or the second containing space for canceling out a pushing force or a pulling force acting on a chamfering knife and prevent the chamfering knife from being damaged.

### BACKGROUND OF THE INVENTION

### 1. Field of the Invention

The present invention relates to a chamfering knife holder, and particularly to a chamfering knife holder that may move telescopically along an axial direction to cancel out a pulling force or a pushing force acting on a chamfering knife.

### 2. Description of Related Art

A tool holder is utilized to mount various kinds of cutting tools onto a spindle of a machine tool. A kind of tool holder for mounting a chamfering knife is regarded as a chamfering knife holder. Part of conventional chamfering knife holders can move telescopically along an axial direction. When an unexpected force caused by an uneven surface of a workpiece acts on a chamfering knife, the conventional chamfering knife holders mentioned above can cancel out the unexpected force via their axial extension or retraction to prevent the chamfering knife from being damaged.

However, each one of the conventional chamfering knife holders mentioned above can only be applied in one single situation. Specifically, when a pushing force caused by a workpiece pushes a chamfering knife toward a chamfering knife holder, a conventional chamfering knife holder applied in the situation above often chooses to set up a compression spring inside. The compression spring enables the conventional chamfering knife holder to axially retract and cancel out the pushing force caused by the workpiece.

In another situation, a pulling force caused by a workpiece pulls a chamfering knife away from a chamfering knife holder. A conventional chamfering knife holder applied in this situation may choose to set up an extension spring inside instead of the compression spring or choose to similarly set up a compression spring but with different interior construction, so that the pulling force caused by the workpiece can be canceled out.

Overall, since each one of the conventional chamfering knife holders mentioned above can only be applied in one specific situation, users have to prepare different conventional chamfering knife holders for different situations and replace the conventional chamfering knife holders in different situations, which increases the cost of machining.

To overcome the shortcomings of the conventional chamfering knife holders, the present invention tends to provide a chamfering knife holder to mitigate or obviate the aforementioned problems.

### SUMMARY OF THE INVENTION

The main objective of the present invention is to provide a chamfering knife holder, and particularly to a chamfering knife holder that may move telescopically along an axial direction to cancel out a pulling force or a pushing force acting on a chamfering knife.

The chamfering knife holder comprises a mounting cover, a protrusion, a mounting assembly, a first containing space, a second containing space, and a resilient element. The mounting cover is hollow and has an internal peripheral surface surrounding an interior of the mounting cover. The protrusion circularly protrudes from the internal peripheral surface of the mounting cover and is enclosed to form a through hole. The mounting assembly is detachably and movably mounted in the interior of the mounting cover. The first containing space and the second containing space are both enclosed by the mounting cover, the protrusion, and the mounting assembly. The first containing space and the second containing space communicate with each other via the through hole. The resilient element is selectively disposed in the first containing space or the second containing space and two opposite ends of the resilient element respectively abut against the mounting assembly and the protrusion. The resilient element is utilized to cancel out a pushing force or a pulling force acting on a chamfering knife.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a chamfering knife holder in accordance with the present invention;

FIG. 2 is a partially cross-sectional perspective view of the chamfering knife holder in FIG. 1, showing that a resilient element is disposed in a first containing space;

FIG. 3 is an exploded perspective view of the chamfering knife holder in FIG. 1;

FIG. 4 is a side view in partial section of the chamfering knife holder in FIG. 1, showing that the resilient element is disposed in the first containing space;

FIG. 5 is another operational perspective view of the chamfering knife holder in accordance with the present invention;

FIG. 6 is a partially cross-sectional perspective view of the chamfering knife holder in FIG. 5, showing that the resilient element is disposed in a second containing space;

FIG. 7 is an exploded perspective view of the chamfering knife holder in FIG. 5; and

FIG. 8 is a side view in partial section of the chamfering knife holder in FIG. 5, showing that the resilient element is disposed in the second containing space.

### DETAILED DESCRIPTION OF THE PREFERRED EMBODIMENT

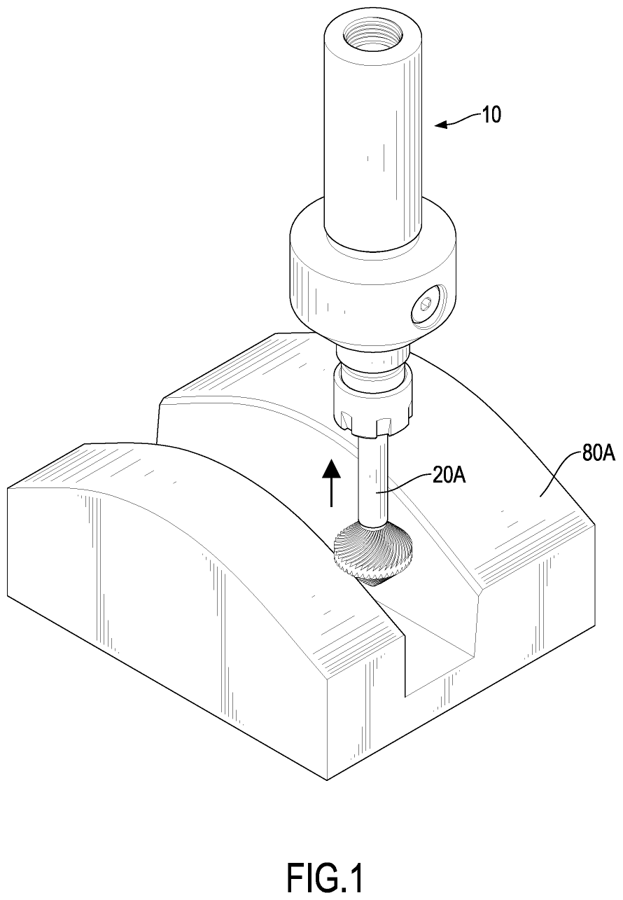

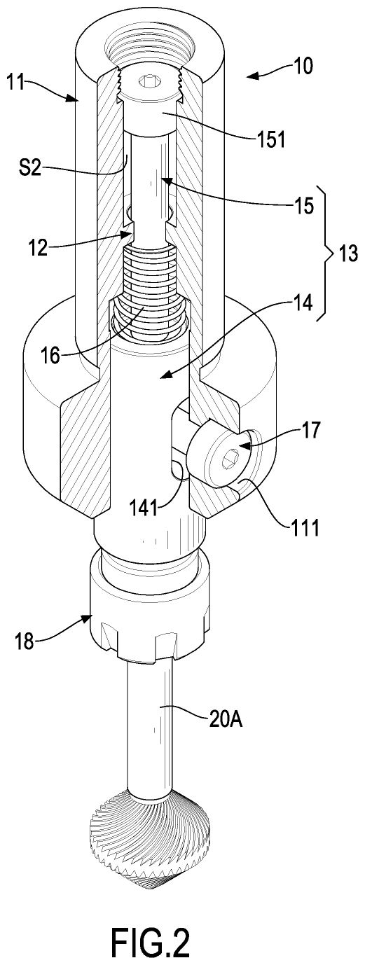

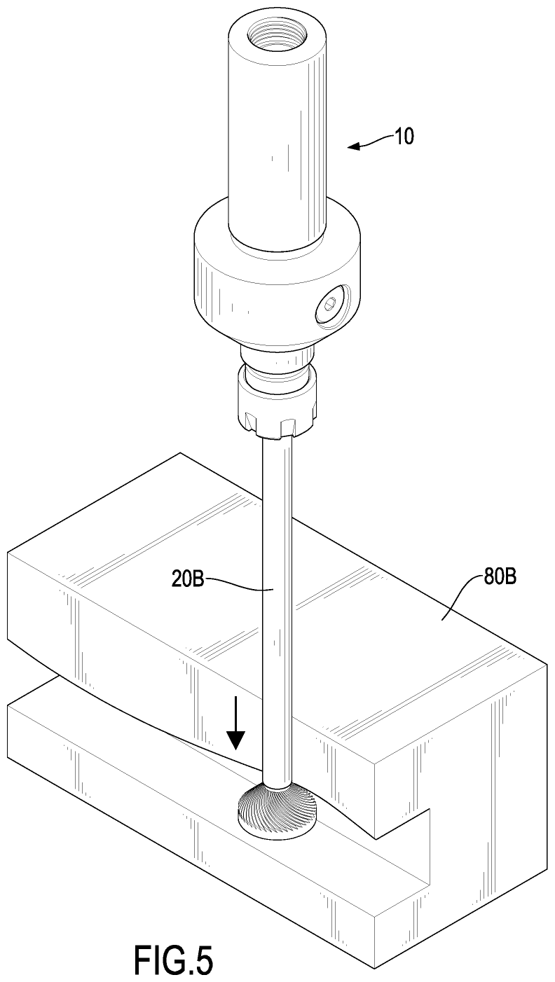

With reference to FIGS. 1 and 5, a chamfering knife holder 10 in accordance with the present invention is applied to cancel out a pushing force or a pulling force acting on a chamfering knife 20A/20B by a workpiece 80A/80B. With reference to FIGS. 2, 4, 6, and 8, the chamfering knife holder 10 has an axis A, an axial direction along the axis A, a mounting cover 11, a protrusion 12, a mounting assembly 13, a first containing space S1, a second containing space S2, a resilient element 16, a connecting pin 17, and a tool clamping assembly 18.

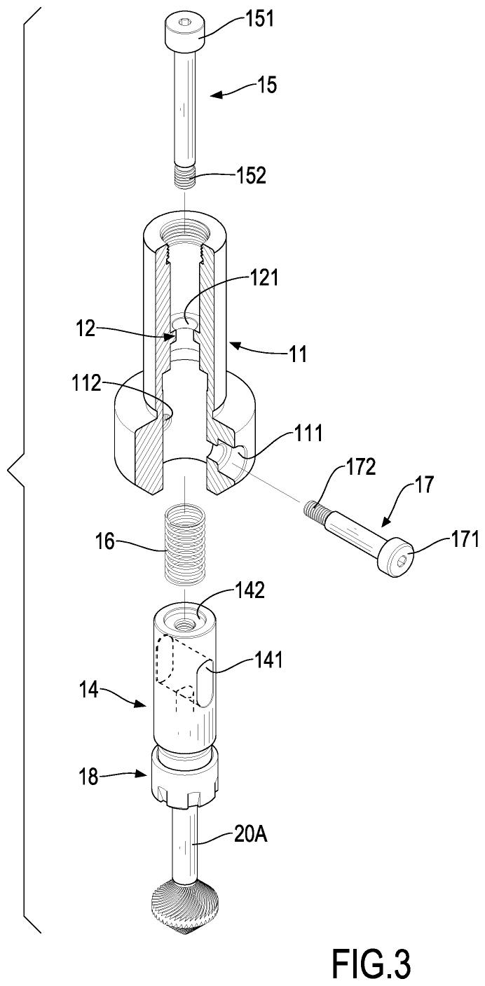

With reference to FIGS. 3, 4, 7, and 8, the mounting cover 11 is hollow and is elongated along the axial direction of the chamfering knife holder 10. The mounting cover 11 has an internal peripheral surface surrounding an interior of the mounting cover 11, a counterbore 111, and a threaded hole 112. The counterbore 111 and the threaded hole 112 are both radially defined through the mounting cover 11, both communicate with the interior of the mounting cover 11, and align with each other. The protrusion 12 circularly protrudes from the internal peripheral surface of the mounting cover 11 toward the axis A of the chamfering knife holder 10 and is enclosed to form a through hole 121.

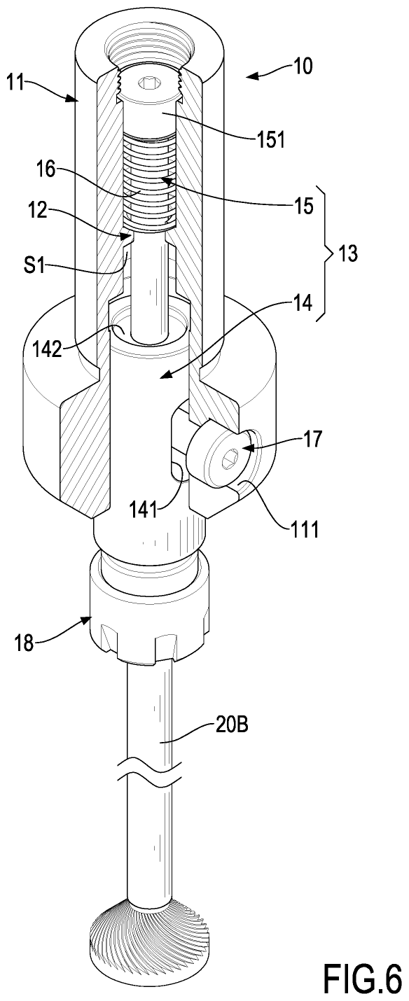

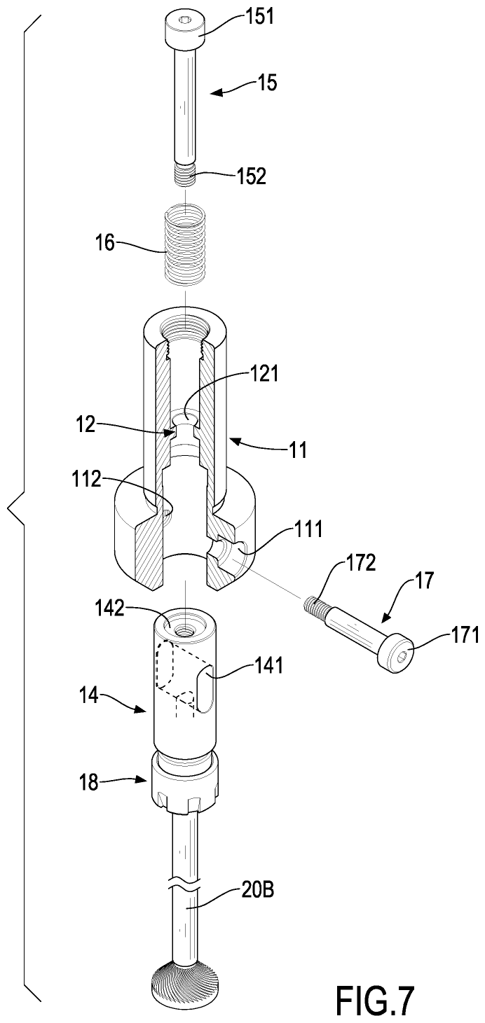

With reference to FIGS. 2, 4, 6, and 8, the mounting assembly 13 is detachably and movably mounted in the interior the mounting cover 11 along the axial direction and has a mounting unit 14 and a pressing shaft 15. With reference to FIGS. 3 and 7, the mounting unit 14 has a top portion, a bottom portion, an elongated hole 141, and a groove 142. With reference to FIGS. 2 and 6, the top portion of the mounting unit 14 and the bottom portion of the mounting unit 14 are opposite each other in an axial direction of the mounting unit 14. With reference to FIGS. 2 and 6, the top portion of the mounting unit 14 is inserted into the interior of the mounting cover 11, and the tool clamping assembly 18 is mounted on the bottom portion of the mounting unit 14.

With reference to FIGS. 3, 4, 7, and 8, the elongated hole 141 is radially defined through the mounting unit 14 and located between the top portion of the mounting unit 14 and the bottom portion of the mounting unit 14. With reference to FIGS. 2 and 6, the groove 142 is recessed on the top portion of the mounting unit 14 and faces the protrusion 12.

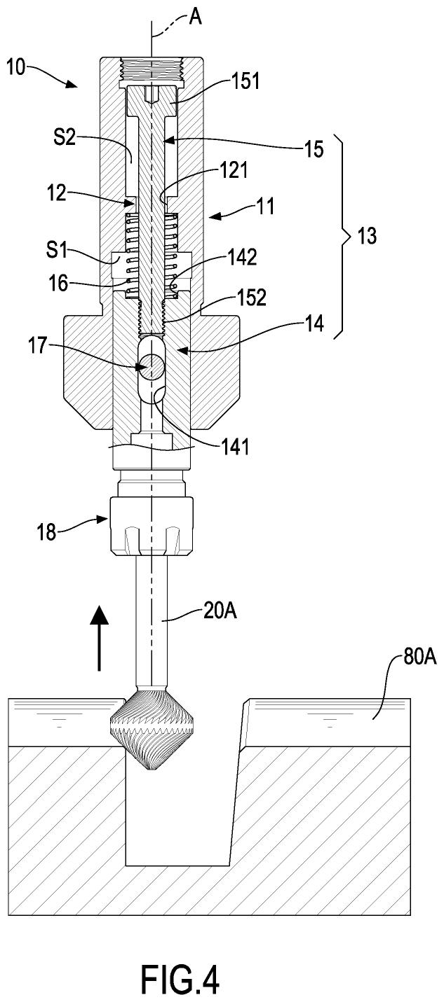

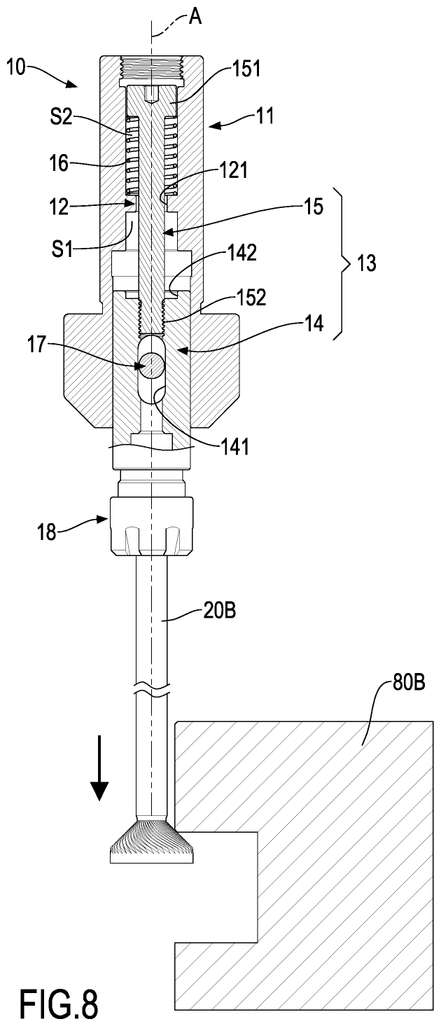

With reference to FIGS. 4 and 8, the pressing shaft 15 is disposed in the interior of the mounting cover 11 and is mounted through the through hole 121. With reference to FIGS. 3 and 7, the pressing shaft 15 has a top end, a bottom end, a pressing block 151, and a connecting portion 152. The top end of the pressing shaft 15 and the bottom end of the pressing shaft 15 are opposite each other in an axial direction of the pressing shaft 15. The pressing block 151 is located at the top end of the pressing shaft 15 and the connecting portion 152 is located at the bottom end of the pressing shaft 15. With reference to FIGS. 3, 4, 7, and 8, the mounting unit 14 further has a screw hole axially formed through a bottom of the groove 142 and communicating with the elongated hole 141 of the mounting unit 14. The connecting portion 152 is screwed into the screw hole of the mounting unit 14, and the pressing shaft 15 and the mounting unit 14 are thus detachably connected to each other.

With reference to FIGS. 2, 4, 6, and 8, the first containing space S1 and the second containing space S2 are both axially defined inside the mounting cover 11. The first containing space S1 and the second containing space S2 are separated by the protrusion 12 and communicate with each other via the through hole 121. With reference to FIGS. 6 and 8, the first containing space S1 is enclosed by the mounting cover 11, the protrusion 12, and the top portion of the mounting unit 14. With reference to FIGS. 2 and 4, the second containing space S2 is enclosed by the mounting cover 11, the protrusion 12, and the pressing block 151 of the pressing shaft 15.

With reference to FIGS. 4 and 8, the resilient element 16 is selectively disposed in the first containing space S1 or the second containing space S2, and two opposite ends of the resilient element 16 respectively abut against the mounting assembly 13 and the protrusion 12. The resilient element 16 is preferably a compression spring.

With reference to FIGS. 2, 4, 6, and 8, the connecting pin 17 is detachably and radially mounted in the mounting cover 11 and is movably mounted through the elongated hole 141 of the mounting unit 14. With reference to FIGS. 3 and 7, the connecting pin 17 has a pin head 171 and a threaded rod portion 172 respectively located at two opposite ends of the connecting pin 17. The pin head 171 is contained in the counterbore 111 of the mounting cover 11, and the threaded rod portion 172 is screwed into the threaded hole 112 of the mounting cover 11 via the elongated hole 141.

With reference to FIGS. 2, and 6, the tool clamping assembly 18 is mounted on the bottom portion of the mounting unit 14 and is utilized to clamp a chamfering knife 20A/20B. The tool clamping assembly 18 preferably includes a collet and a collet nut corresponding to the collet, and the detailed structures and operating principles of the tool clamping assembly 18 are conventional and are not to be described in detail.

In use, the chamfering knife holder 10 in accordance with the present invention can be applied in two situations as respectively shown in FIGS. 1 and 5.

With reference to FIG. 1, a pushing force caused by a workpiece 80A pushes a chamfering knife 20A toward the chamfering knife holder 10. In the situation shown in FIG. 1, with reference to FIGS. 2 and 4, the resilient element 16 is disposed in the first containing space S1, and the two opposite ends of the resilient element 16 respectively abut against the protrusion 12 and the bottom of the groove 142 of the mounting unit 14. With reference to FIG. 4, the mounting assembly 13 and the chamfering knife 20A move upwardly along the axial direction of the chamfering knife holder 10 due to the pushing force. The chamfering knife holder 10 thus axially retracts, and the resilient element 16 is compressed by the mounting unit 14 and cancels out the pushing force.

With reference to FIG. 5, a pulling force caused by a workpiece 80B pulls a chamfering knife 20B away from the chamfering knife holder 10. In the situation shown in FIG. 5, with reference to FIGS. 6 and 8, the resilient element 16 is disposed in the second containing space S2, and the two opposite ends of the resilient element 16 respectively abut against the protrusion 12 and the pressing block 151 of the pressing shaft 15. With reference to FIG. 8, the mounting assembly 13 and the chamfering knife 20A move downwardly along the axial direction of the chamfering knife holder 10 due to the pulling force. The chamfering knife holder 10 thus axially extends, and the resilient element 16 is compressed by the pressing shaft 15 and cancels out the pulling force.

Overall, the chamfering knife holder 10 in accordance with the present invention may cancel out a pulling force or a pushing force via the resilient element 16 disposed in the first containing space S1 or the second containing space S2. Thereby, users can apply the chamfering knife holder 10 in situations of canceling out a pulling force and canceling out a pushing force without preparing another chamfering knife holder.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A chamfering knife holder comprising:
a mounting cover being hollow and having an internal peripheral surface surrounding an interior of the mounting cover;
a protrusion circularly protruding from the internal peripheral surface of the mounting cover and enclosed to form a through hole;
a mounting assembly detachably and movably mounted in the mounting cover and having
a mounting unit having
a top portion inserted into the interior of the mounting cover; and
a bottom portion opposite the top portion in an axial direction of the mounting unit; and
a pressing shaft mounted through the through hole and having
a top end;
a bottom end opposite the top end in an axial direction of the pressing shaft and detachably connected to the top portion of the mounting unit; and
a pressing block disposed at the top end of the pressing shaft;
a first containing space enclosed by the mounting cover, the protrusion, and the top portion of the mounting unit and communicating with the through hole;
a second containing space enclosed by the mounting cover, the protrusion, and the pressing block of the pressing shaft and communicating with the through hole;
a resilient element axially disposed inside the mounting cover, selectively disposed in the first containing space or the second containing space, and having two opposite ends respectively abutting against the mounting assembly and the protrusion; and
a tool clamping assembly mounted on the bottom portion of the mounting unit.

2. The chamfering knife holder as claimed in claim 1, wherein
the mounting unit has an elongated hole radially defined through the mounting unit and located between the top portion of the mounting unit and the bottom portion of the mounting unit; and
the chamfering knife holder has a connecting pin detachably and radially mounted in the mounting cover and movably mounted through the elongated hole of the mounting unit.

3. The chamfering knife holder as claimed in claim 2, wherein
the mounting cover has
a threaded hole radially defined through the mounting cover; and
a counterbore radially defined through the mounting cover and aligning with the threaded hole; and
the connecting pin has
a pin head contained in the counterbore of the mounting cover; and
a threaded rod portion opposite the pin head and screwed into the threaded hole of the mounting cover via the elongated hole.

4. The chamfering knife holder as claimed in claim 3, wherein
the mounting unit has a screw hole axially defined on the top portion of the mounting unit; and
the pressing shaft has a connecting portion located at the bottom end of the pressing shaft and screwed into the screw hole of the mounting unit.

5. The chamfering knife holder as claimed in claim 1, wherein
the resilient element is disposed in the first containing space; and
the two opposite ends of the resilient element respectively abut against the top portion of the mounting unit and the protrusion.

6. The chamfering knife holder as claimed in claim 2, wherein
the resilient element is disposed in the first containing space; and
the two opposite ends of the resilient element respectively abut against the top portion of the mounting unit and the protrusion.

7. The chamfering knife holder as claimed in claim 3, wherein
the resilient element is disposed in the first containing space; and
the two opposite ends of the resilient element respectively abut against
the top portion of the mounting unit and the protrusion.

8. The chamfering knife holder as claimed in claim 5, wherein the mounting unit has
a groove recessed on the top portion of the mounting unit and facing the protrusion; and
the two opposite ends of the resilient element respectively abut against a bottom of the groove of the mounting unit and the protrusion.

9. The chamfering knife holder as claimed in claim 6, wherein the mounting unit has
a groove recessed on the top portion of the mounting unit and facing the protrusion; and
the two opposite ends of the resilient element respectively abut against a bottom of the groove of the mounting unit and the protrusion.

10. The chamfering knife holder as claimed in claim 7, wherein the mounting unit has
a groove recessed on the top portion of the mounting unit and facing the protrusion; and
the two opposite ends of the resilient element respectively abut against a bottom of the groove of the mounting unit and the protrusion.

11. The chamfering knife holder as claimed in claim 8, wherein the resilient element is a compression spring.

12. The chamfering knife holder as claimed in claim 9, wherein the resilient element is a compression spring.

13. The chamfering knife holder as claimed in claim 10, wherein the resilient element is a compression spring.

14. The chamfering knife holder as claimed in claim 1, wherein
the resilient element is disposed in the second containing space; and
the two opposite ends of the resilient element respectively abut against the pressing block of the pressing shaft and the protrusion.

15. The chamfering knife holder as claimed in claim 2, wherein
the resilient element is disposed in the second containing space; and
the two opposite ends of the resilient element respectively abut against the pressing block of the pressing shaft and the protrusion.

16. The chamfering knife holder as claimed in claim 3, wherein
the resilient element is disposed in the second containing space; and
the two opposite ends of the resilient element respectively abut against the pressing block of the pressing shaft and the protrusion.

17. The chamfering knife holder as claimed in claim 14, wherein the resilient element is a compression spring.

18. The chamfering knife holder as claimed in claim 15, wherein the resilient element is a compression spring.

19. The chamfering knife holder as claimed in claim 16, wherein the resilient element is a compression spring.
